(19) United States
(12) Patent Application Publication
(10) Pub. No.: US 2026/0134461 A1
(43) Pub. Date: May 14, 2026

(54) SYSTEM AND METHOD USING A SOCIAL MEDIA PLATFORM IN REAL-TIME FOR REMOTE AND PUBLIC GIFTING AND ACTS OF KINDNESS

(71) Applicant: Fadi Hanna, Shelby Township, MI (US)

(72) Inventor: Fadi Hanna, Shelby Township, MI (US)

(21) Appl. No.: 19/194,174

(22) Filed: Apr. 30, 2025

Related U.S. Application Data
(60) Provisional application No. 63/720,248, filed on Nov. 14, 2024.

(51) Int. Cl. G06Q 30/0601; G06Q 50/00

(52) U.S. Cl. CPC G06Q 30/0603; G06Q 10/40; G06Q 30/0641

(57) ABSTRACT

A method and system for establishing a social media platform configured to facilitate real-time public gifting and communication between account holders and remote vendors includes the steps of providing a digital interface that enables account holders to create profiles and connect with other account holders and for enabling real-time communication between the account holders and remote vendors, retailers, and restaurants via the platform. The method includes allowing account holders to purchase gifts, products, or services from the remote vendors, retailers, and restaurants through the platform. The method may also include enabling public posting of the purchased gifts, products, or services to other account holders in a real-time feed, and enabling the recipient of the gift to publicly acknowledge the gift and engage in communication through the platform with the sender and with the retail vendor who supplied it.

### REFERENCE TO RELATED APPLICATIONS

This is a non-provisional patent application claiming the priority of provisional application 63/720,248 filed Nov. 14, 2024 titled System and Method Using a Social Media Platform in Real-Time for Remote and Public Gifting and Acts of Kindness which is incorporated herein by reference in its entirety.

### BACKGROUND OF THE INVENTION

This invention relates generally to a social media platform and software application and, more particularly, to a system and method for using a social media platform for publicly expressing acts of kindness by making reservations, purchasing gifts, and building relationships in real time and in a manner that is made public to predetermined followers on the social media platform.

Perhaps the most traditional gift that one person gives to another is a single or bouquet of flowers such as to commemorate a birthday, anniversary, first date, or even a funeral. In most cases, the giver of the gift has a hope or intention that the receiver of the gift will both enjoy the gift and feel special gratitude to the giver. In modern times, of course, social media platforms such as Facebook, Instagram, Twitter, and the like have become very popular and millions of consumers have accounts on these platforms where they invite friends and followers to join with them whereby to share communications, images, status updates, and other actions in a manner that is visible to other friends and followers.

Although presumably effective for their intended purposes, the existing social media platforms are inadequate to provide prompt vendor responses in real time to consumer gift giving (such as the vendor posting a real-time response video or simply presenting the gift in real-time to the receiving consumer thereof), or enabling public viewing of real-time communications between the gift giver and gift receiver on the social media platform, or simply enhancing real-time communications between friends attempting to coordinate and participate in a social gathering.

Therefore, it would be desirable to have a system and method for establishing a social media platform that enables account holders to engage in remote yet public gifting and communications in real-time. Further, it would be desirable to have a social media platform configured to enable real-time and public exchanges with remote vendors, retailers, and restaurants from whom gifts or reservations have been purchased or posted. In addition, it would be desirable to have a social media platform and software application specifically configured to promote advanced coordination of friends gathering and meeting together in social settings.

### SUMMARY OF THE INVENTION

A method and system according to the present invention for establishing a social media platform configured to facilitate real-time public gifting and communication between account holders and remote vendors includes the steps of providing a digital interface that enables account holders to create profiles and connect with other account holders and for enabling real-time communication between the account holders and remote vendors, retailers, and restaurants via the platform. The method includes allowing account holders to purchase gifts, products, or services from the remote vendors, retailers, and restaurants through the platform. The method may also include enabling public posting of the purchased gifts, products, or services to other account holders in a real-time feed, and enabling the recipient of the gift to publicly acknowledge the gift and engage in communication through the platform with the sender and with the retail vendor who supplied it.

Therefore, a general object of this invention is to provide a social media platform that enables account holders to engage in remote yet public gifting and communications in real-time using the platform.

Another object of this invention is to provide a social media platform configured to enable real-time and public exchanges with remote vendors, retailers, and restaurants from whom gifts or reservations have been purchased for associated account holders (e.g., “friends” or followers).

Still another object of this invention is to provide a social media platform and software application specifically configured to promote advanced coordination of friends gathering and meeting together in a predetermined social setting.

Yet another object of this invention is to provide a social media platform that is configured to enable an account holder to publicly request that another account holder purchase, treat, or spoil him or her with a gift or act of kindness.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a block diagram illustrating the electronic components of a system for establishing and using an online platform for expressing tangible acts of kindness according to a preferred embodiment of the present invention;

FIG. 2 is a block diagram illustrating aspects of the programming for establishing the online platform as in FIG. 1.

FIG. 3 is a flowchart illustrating a methodology for using an online platform for expressing tangible acts of kindness according to a preferred embodiment of the present invention; and

FIG. 4 is a flowchart illustrating the aspect of the online platform as in FIG. 3 that enables platform account holders to communicate with one another and coordinate social events.

### DESCRIPTION OF THE PREFERRED EMBODIMENT

A system and method for using a social media platform for reserving, purchasing, and expressing acts of kindness according to a preferred embodiment of the present invention will now be described with reference to the accompanying drawings.

An overview of the present invention is to have an online social media platform (which may be synonymously referred to as an “online platform” or just a “platform”) where an account holder (i.e. a registered user) can post about going out to dinner to celebrate at restaurant X, or club X, or any establishment and may publish the post online on their page/feed, may tag others, may even list what items are desired to be ordered (e.g., appetizers, dinner, specialties, drinks, bottle service, etc.). Other users can choose to buy the individual or group a gift(s), such as an appetizer, desert, bottle of wine, a drink, or the like and the restaurant/club/bar can be notified via the app, to bring it out and capture the celebration recorded/presented to their guest, and post on the guest timeline identity of the recipient and the purchaser. Another type of gift that may be given to a recipient is simply a “voucher” for an amount of value that the recipient is able to then spend according to his or her own choice. All posts can be liked, shared, commented on, (according to respective privacy settings), where comments may include GIFs, pictures, or videos.

Establishments (such as bars, restaurants, clubs, lounges, shows, concerts, etc.), can submit a menu, a floor plan layout and seating of seats/tables, digitally in the site, and users can view those submissions when making purchasing decisions.

All establishments should be able to post specials or any promotions on their page/feed, such as 30% off appetizers on Tuesdays and Wednesdays between hours of 3 & 6 pm. Or free desert on Thursdays, or today special of the day is bone-in ribeye, wild caught driver scallops, 5 lbs lobster, etc. etc. and post pictures of the dishes. Or, DJ Tiesto hosting a party at night club X Friday, March XX, XXXX.

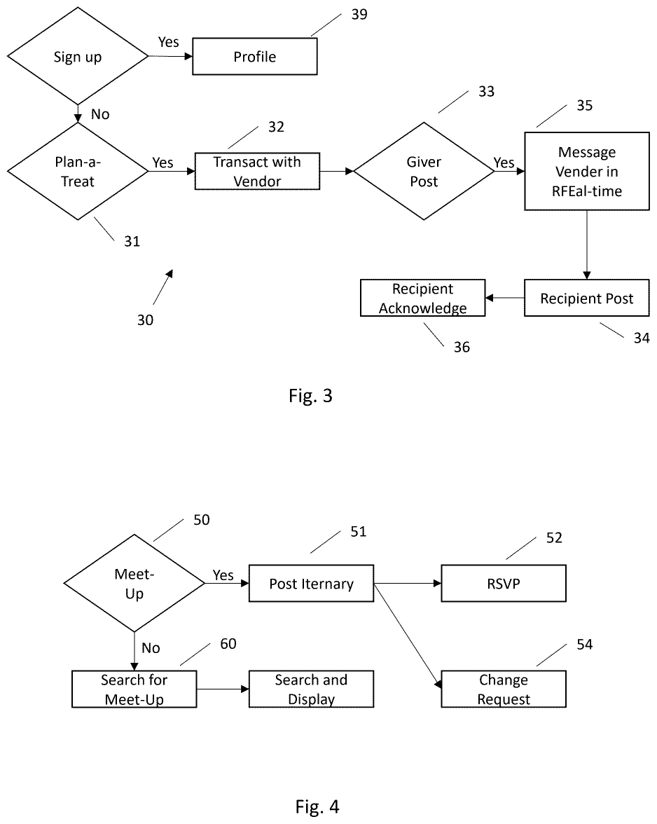

FIG. 3 illustrates the inventive method of planning and sending a gift to another account holder, the illustrated aspect shown using reference character 30. More particularly, if the platform 10 (via the processor 12c executing programming 12a) determines 31 that an account holder 22 has chosen to arrange for and/or purchase a gift or treat for another account holder, then the giver is enabled through the platform 10 to make a transaction 32 with a participating vendor. As explained in more detail elsewhere, the step of making a transaction 32 may include first exploring the vendor's floor plan, menu, gifting options, or the like and, second, using the purchasing module to actually purchase a selected product offering(s). Then, depending on privacy settings by the recipient, the gift giver may be allowed to post 33 details regarding the gift and recipient via the platform 10. In other words, the gift giver may choose to publish the intended “itinerary” that is being bestowed upon a gift recipient, including the date, name of vendor, gifts to be given, and the like

For instance, the recipient of a gift may be empowered to choose to whom a post regarding a gift or purchase may be displayed and to what level of detail the gift or purchase itself may be disclosed. In such an embodiment, the giver or purchaser may be intentionally prevented or excluded from posting depending on the privacy settings of the recipient. An instance of a recipient posting regarding the gift is shown in FIG. 3 at reference character 34 and the recipient may also acknowledge or thank the giver of the gift as shown at reference character 36. From a software perspective, this function may be controlled by the acknowledgment module 44.

For instance, if a gift recipient allows posting, but selects names to be excluded/private in settings, then the post on the restaurant page and the sender page will only show person X (sender) bought product Y for “someone special” or a “friend” at Eddie Vs but the gift receivers identity is not otherwise disclosed. This applies to any and all gifts/requests sent and received in the app.

In a critical aspect of the platform 10, the gift giver may communicate in real-time with the vendor of the gift. For instance, a gift giving account holder 22 is enabled to communicate directly with a restaurant with whom a gift transaction has been made, and said communication facilitating the gift giver giving specific instructions to the restaurant staff or even giving a live message to the recipient at the very moment the recipient is being presented with the gift, i.e., “Happy Birthday, Grandma!” This feature is shown in FIG. 3 at reference character 35.

In another embodiment, account holders 22 are enabled to communicate with other account holders so as to coordinate a physical or virtual meeting at a designated remote location (see FIG. 4). Similar to the privacy settings described above, privacy settings may provide constraints on the default paradigm allowing posting to the platform. For instance, there may be options to post who all is invited, who all is going as friends (tag them), the location that was selected, items from the establishment menu, and the like.

Users should be able to have a detailed preferences option in the user's profile, to select and choose their likes and desires to be able to see what matter most to them in their feed, and help them best connect with people/others that they want and desire, and how to make best going out decisions and knowing where people are going or planning on going, to be able to make best plans or gifts in advance. In other words, registered users or platform account holders will be enabled to generate profiles so that being matched with vendors whose offerings correspond to respective profiles will make gift or purchase selections more efficient.

It is understood that the platform described above may enable one group to post their intentions to visit a restaurant such that a second group may choose to offer the first group a gift or make a purchase for the first group. For instance, one or more male account holders might learn via the platform 10 that one or more female account holders plan to visit a restaurant or club and the mail account holders may choose to offer to buy a food or beverage item for the female account holders. Obviously, this is just one example and other examples using the present social media platform are numerous.

In another aspect, the social media platform (which may be accessed as a mobile app from a smart phone or other electronic device) may include a payment module through which respective gifts for purchases may be facilitated. For instance, the payment plus purchasing module 40 may enable an account holder 22 to make a credit card purchase, a purchase debited directly from a user's checking account, or the like. More particularly, the processing of a purchase of a gift or items on the app, may include a credit card processing fee, other app processing standard fee, or optional TIP fee for the server/wait staff at the restaurant or club/establishment.

In another aspect, the social media platform described herein may be linked to other or existing social media platforms such as Facebook, Instagram, or the like such that an account holder's friends from other social media platforms may be more easily transferred or ported to the present platform. Similarly, the present platform may be in data communication with other service networks such as limousine service, florists, food delivery, travel sites, and the like.

In another aspect, the platform may be configured or may include a communications module 46 and that enables account holders to coordinate social events or “meet ups” 50. This embodiment is illustrated in FIG. 4. For instance, a respective account holder may post an event or a proposed event at a proposed designated location along with a proposed date and time (see the step labeled 51). In other words, a respected friend may inquire of others regarding a desire or willingness of others to meet up at the proposed location at the proposed time (step 50). The “other friends” who see the post may reply back in real time to essentially RSVP (step 52), to decline, or to suggest a modified itinerary (step 54). Then, in an embodiment, the requesting account holder may make a reservation, make advance purchases, may have real-time communications with the vendor, or any other functionality described herein.

In a variation of the meet-up embodiment, account holders can also use the platform to search 60 (such as by destination name, location, or manually by ZIP Code) to learn what events are taking place, who is attending, and the like. In some embodiments, even searching for a specific DJ or other entertainment options may be possible. Stated another way, an account holder can search for Meetup type events that have been planned or proposed by his set of friends (co-account holders on the platform).

In still another aspect, the social media platform according to the present invention may have some sort of a “status” built in for users that may correspond to amounts of money spent on gifts for others or even for the amount of money by way of gifts received by respective user within a given amount of time, such as in a month, in a calendar quarter, or in a year. This functionality may be a part of a analytics module that, when activated, generates statistics on use of the platform by an account holder or even on a vendor. For instance, an account holder may be able to determine on what dates the platform was utilized, what gifts were given, amount of money that was spent, and the like. Similarly, a vendor may determine when their services were utilized, amounts of revenue that were generated, or what activities had been donated. The analytics are not limited to these examples.

Optionally, the platform may include various financial planning tools to enable an account holder to save money toward a goal of being able to purchase a gift remotely for another account holder. For example, a college student may use platform financial planning tools to accumulate a date donation needed to “spoil” another account holder with whom he hopes to date via the platform. In a related variation, the giver of gifts intended to spoil another account holder may use the platform to publicize what gifts or even the amount or value of the gifts were given.

In a critical aspect, the platform may include a feature which enables an account holder to essentially ask the full or a partial set of their friends (e.g., other account holders) to purchase one or more gifts for them. In other words, a requesting account holder may ask her friends to “shower” her or “spoil” her with gifts from participating vendors such as for the celebration of a birthday, anniversary, work promotion, or the like. The variations on the feature of requesting gifts from one's friends on a social media platform are numerous. In a variation of this feature, the act of a “spoil me” request may function as a competition to grant the opportunity to spoil a requester to the highest bidder.

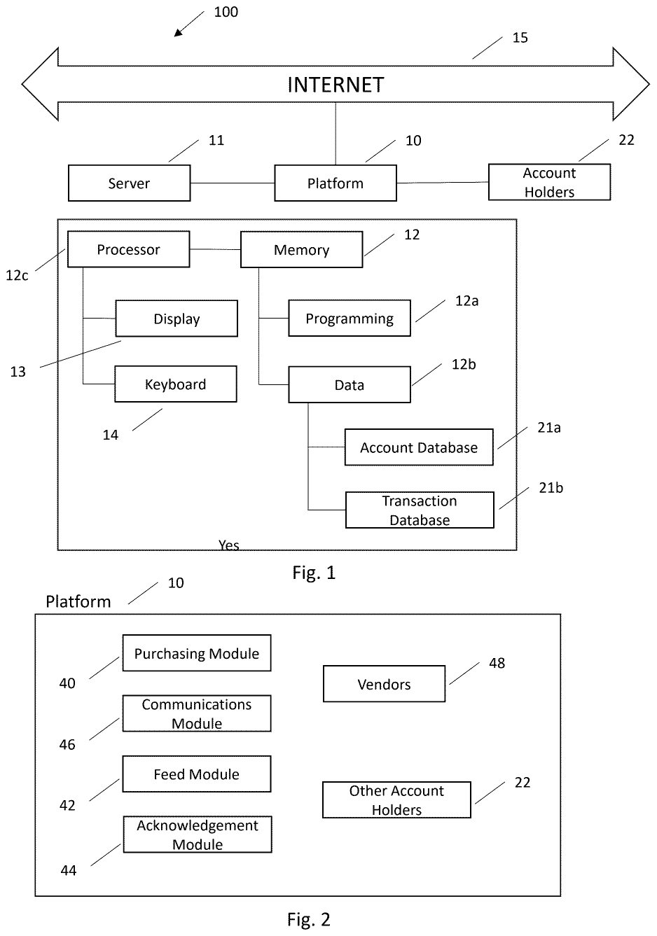

The accompanying figures illustrate the computer system and methodology described in the present specification. FIG. 1 illustrates the physical context and computer equipment capable of implementing the system and method described herein. More particularly, the system and methodology 100 and for establishing and using an online social media platform 10 that enables account holders 20 to identify, reserve, purchase, give, and promote gifts for treats to one or more corresponding account holders (i.e., giving gifts to friends via an online social media platform) may be implemented and accomplished via a computer server 11 connected and in data communication with the Internet 15. The server 11 may include or be in data communication with a non-volatile memory 12 that is configured to store programming instructions 12a and data 12b. Further, the server 11 may include a processor 12c that is in communication with the memory 12 and configured to execute the programming instructions stored thereon. Still further, the server 11 may be electrically connected to a display 13 and to a keyboard 14, the display and keyboard being referred to as a “digital interface” by which a user may interact with the platform 10. It is understood that the keyboard and display may have a unitary or integrated construction such as a touch screen combination and which may also be referred to as a Graphic User Interface (GUI).

As will be described in more detail below, the online platform 10 which is, on the one hand, a program or “app’ stored in the memory 12 device of the computer server 11, and which is, on another hand, an online page for use on the Internet 100, is structured to include some structures that are commonly understood by users of social media. For instance, the platform 10 according to the present invention, may include a plurality of account holders 20 (times referred to as “friends”) each preparing a profile of preferences (as shown as step 39 in FIG. 3). Accordingly, the system may include an account database 21a of account holders and associated data associated with each one. It is understood that a user's preferences may be lined up with a vendors'offerings, such as on the display, to make it easier and more efficient for an account holder 22 identifying and making gifting or purchasing choices. Accessing or displaying a vendor's gifting options may be referred to herein as a “curated list of options.” In addition, the system may include a transaction database 21b stored in memory 12 having data that correlates the transaction history associated with each account holder. This information may be helpful to account holders as they make gifting purchases and choices, i.e., this record may lower the likelihood of a user giving the same gift to the same person repeatedly or perhaps will simply give an idea to an uncertain user.

FIG. 2 illustrates that the programming implementing the invention described herein may include a plurality of programming modules, each module being configured to enable a user to carry out specific functions. More particularly, the platform 10 may include a purchasing module 40 configured to enable an account holder to make and pay for purchases via the platform 10, a feed module 42 specifically configured to enable the public posting on the platform 10 in real-time regarding purchased guests, and acknowledgment module 44 configured to allow recipients of gifts or purchases to publicly acknowledge or thank the account holder who gave the gift, and a communications module 46 specifically configured to enable a gift-giving account holder to have real-time communications with other account holders, with vendors from whom gifts may be purchased, and even in real-time with retailers such as restaurant managers or staff who are actively facilitating, rendering, or bestowing a gift upon the consumer who has been singled out by the gift-giving account holder. It will be understood that the communications module 46 is configured to enable text, audio, or video messaging in real-time. In other words, messaging is not just sending attachments “after the fact” but, rather, even video conferencing type messages are “live” as a gift is given. Obviously, restaurant managers or staff who are participating in the online platform described herein are committing to a potentially time-consuming and major innovation in the restaurant, catering, gifting, or entertainment industry.

It is understood that while certain forms of this invention have been illustrated and described, it is not limited thereto except insofar as such limitations are included in the following claims and allowable functional equivalents thereof.

1-27. (canceled)

28. A computer-implemented method executed by a server for controlling real-time delivery of a gift in connection with a social media platform, the method comprising:
providing, by the server, a digital interface enabling account holders to create profiles and connect with other account holders;
establishing, by the server, a communication session among a sender device, a recipient device, and a vendor staff terminal located at a vendor location where a vendor staff member is physically serving the recipient;
receiving, by the server, purchase confirmation data from a purchasing module indicating that a gift has been purchased from the vendor;
receiving, by the server, geolocation verification data confirming physical presence of the recipient device at the vendor location;
receiving, by the server, delivery confirmation data from the vendor staff terminal indicating that the gift has been delivered to the recipient;
maintaining, by the server, a delivery transaction state for the gift, the delivery transaction state being automatically advanced by the server only upon receipt of the purchase confirmation data, the geolocation verification data, the delivery confirmation data,
confirmation that the communication session is active among the sender device, the recipient device, and the vendor staff terminal;
synchronizing, by the server, transaction data associated with the delivery transaction state across the sender device, the recipient device, and the vendor staff terminal in real time during the communication session; and
enabling public posting of the gift to a feed of the social media platform only after the delivery transaction state reaches a confirmed-delivery state.

29. A server-based system for controlling real-time delivery of a gift in connection with an online social media platform, the system comprising:
a server in data communication with a non-volatile memory storing programming instructions;
a digital interface accessible to account holders and configured to enable profile creation and communication;
a purchasing module configured to receive purchase confirmation data for a gift from a vendor;
a communication module configured to establish a live communication session among a sender device, a recipient device, and a vendor staff terminal located at a vendor location;
a geolocation verification component configured to confirm physical presence of the recipient device at the vendor location;
a transaction state controller implemented by the server and configured to:
receive purchase confirmation data from the purchasing module,
receive geolocation verification data from the geolocation verification component,
receive delivery confirmation data from the vendor staff terminal,
confirm that the live communication session is active, and
automatically advance a delivery transaction state for the gift only when all of said data are received;
a feed module configured to publicly post the gift on the social media platform;
wherein the transaction state controller prevents the feed module from publicly posting the gift until the delivery transaction state reaches a confirmed-delivery state; and
wherein the server synchronizes transaction data associated with the delivery transaction state across the sender device, the recipient device, and the vendor staff terminal in real time.
